(19) United States
(12) Patent Application Publication
(10) Pub. No.: US 2021/0074044 A1
(43) Pub. Date: Mar. 11, 2021

(54) METHOD, SERVER, AND RECORDING MEDIUM FOR CREATING COMPOSITE IMAGE

(71) Applicant: LINE Plus Corporation, Seongnam-si (KR)

(72) Inventors: Jae-hun JUNG, Seongnam-si (KR); Hae Seong CHOI, Seongnam-si (KR)

(73) Assignee: LINE Plus Corporation, Seongnam-si (KR)

(21) Appl. No.: 17/008,821

(22) Filed: Sep. 1, 2020

(30) Foreign Application Priority Data
Sep. 5, 2019 (KR) 10-2019-0110207

(51) Int. Cl. G06T 11/60; G06T 7/90; G06F 3/14; H04N 9/75; G06K 9/00

(52) U.S. Cl. CPC G06T 11/60; G06T 7/90; G06F 3/14; G06T 2200/24; G06K 9/00624; G06T 2207/20221; H04N 9/75

(57) ABSTRACT

Provided are methods, servers, and recording mediums for creating a composite image. The method includes identifying a composition target object included in an input image, determining an insertion content associated with the identified composition target object, and synthesizing the insertion content with the region of the composition target object to create an output image.

### CROSS REFERENCE TO RELATED APPLICATION

The present application claims priority to Korean Patent Application No. 10-2019-0110207, filed Sep. 5, 2019, the entire contents of which is incorporated herein for all purposes by this reference.

### BACKGROUND

### 1. Field

Example embodiments relate to methods, servers, and/or recording mediums for creating a composite image by synthesizing other content with an input image. More particularly, some example embodiments relate to methods and servers for creating and providing various personalized composite images to users on the basis of the same input image through identifying at least one object present in the input image, determining an associated content, and synthesizing the associated content with the region of the object. Some example embodiments also provide recording mediums on which a computer program for implementing the method is recorded.

### 2. Description of the Related Art

As a technique for creating a new image by synthesizing two images, a chroma key technique is well known. The chroma key technique is based on the principle that when a subject is photographed against a single color background and the background is then removed, only the subject remains. The single color background is referred to as a chroma back. In most cases, a red, green, or blue chroma back is used. Among them, the blue chroma back is most preferred. However, colors used for the chroma back are not limited thereto. Any color can be used to compose a chroma back.

According to a conventional chroma key technique, a connection is not considered between a region (hereinafter, referred to as “chroma key region”) that corresponds to a chroma back, which is to be removed or to processed to be transparent within an original image, and an insertion content which is to be synthesized with the chroma key region. Therefore, although an original image has multiple chroma key regions, it is difficult to freely synthesize associated contents with the chroma key regions.

### SUMMARY

An objective of example embodiments is to provide a method for creating a composite image to generate a personalized image from an input image.

Another objective of example embodiments is to provide a method for creating a composite image that involves identifying at least one object in an input image and synthesizing the region of the identified object with an associated content.

A further objective of example embodiments is to provide a method for creating a composite image that includes identifying at least one chroma key region in an input image, identifying an object associated with the chroma key region, and composing the region of the object with a content associated with the object.

A yet further objective of example embodiments is to provide a server or a system serving as a composite image creation apparatus for performing the method for creating a composite image.

A yet further objective of example embodiments is to provide a computer-readable recording medium storing a computer program for execution by a processor that when executed by the processor causes the processor to perform the method for creating a composite image is recorded.

The objectives of example embodiments are not limited to the above-mentioned ones, and other objectives which are not mentioned above will be clearly understood from the following description by those skilled in the art.

One aspect of example embodiments provides a method for creating a composite image, the method executed by a computing device including at least one processor, the method includes identifying, by the at least one processor, a composition target object included in an input image, determining, by the at least one processor, an insertion content associated with the identified composition target object, and synthesizing, by the at least one processor, the insertion content with the region of the composition target object to create an output image.

In the method, the input image may include at least one chroma key region. The identifying the composition target object may include detecting the chroma key region and identifying an object associated with the detected chroma key region as the composition target object.

In the method, the identifying the composition target object may include identifying the composition target object based on a color key, a size, a shape of the detected chroma key region, or any combination thereof.

In the method, the identifying the composition target object may include identifying the composition target object by applying an object recognition technique to an object included in the input image.

The method may further include associating at least one accessible content with the composition target object, and storing content information including association information between each of the at least one accessible content and the composition target object in the computing device.

In the method, the determining the insertion content may include determining at least one of the at least one accessible content associated with the identified composition target object as at least one candidate content based on the content information, and determining one of the at least one candidate content as the insertion content based on user profile information.

In the method, the user profile information may include at least one of personnel information, preference information, or history information of a user.

In the method, the determining the insertion content may include determining at least one of the at least one accessible content associated with the identified composition target object as the at least one candidate content based on the content information, displaying the at least one candidate content, receiving a user input selecting one of the at least one candidate content from a user of the computing device, and determining one of the at least one candidate content based on the user input as the insertion content.

In the method, the creating the output image may include modifying the insertion content on the basis of the region occupied by the identified composition target object, and synthesizing the modified insertion content with the region occupied by the identified composition target object.

In the method, the modifying of the insertion content may comprise changing at least one factor of a size, an inclination, or a shape of the insertion content such that the modified insertion content matches the region occupied by the identified composition target object.

Another aspect of example embodiments provides a server for creating a composite image. The server includes one or more processors configured to execute the computer-readable instructions such that the server is configured to obtain an input image, identify a composition target object included in the input image, determine an insertion content associated with the identified composition target object, create an output image by synthesizing the insertion content with a region occupied by the composition target object in the input image, and transmit the output image to a user device over a network.

In the server, the input image may include at least one chroma key region, and the one or more processors may be further configured to detect the chroma key region and identify an object associated with the detected chroma key region as the composition target object.

In the server, the one or more processors may be configured to cause the server to identify the composition target object based on a color key, a size, a shape of the detected chroma key region, or any combination thereof.

In the server, the one or more processors may be configured to cause the server to identify the composition target object by applying an object recognition technique to an object included in the input image.

The one or more processors may be further configured to cause the server to associate at least one accessible content with the composition target object, and store associated information between each of the at least one accessible content and the composition target object.

In the server, the one or more processors may be further configured to cause the server to determine at least one of the at least one accessible content associated with the identified composition target object as at least one candidate content based on the content information and determine one of the at least one candidate content as the insertion content based on profile information of a user of the user device.

In the server, the one or more processors may be further configured to cause the server to determine at least one of the at least one accessible content associated with the identified composition target object as at least one candidate content based on the content information, transmit the candidate contents to the user device, receive a user input selecting one of the at least one candidate content from a user of the user device, and determine the at least one candidate content selected by the user input as the insertion content.

In the server, the one or more processors may be further configured to cause the server to modify the insertion content based on the region occupied by the identified composition target object and synthesize the modified insertion content with the region of the composition target object.

In the server, the one or more processors are further configured to cause the server to modify a size, an inclination, a shape of the insertion content, or any combination thereof such that the insertion content matches the region occupied by the identified composition target object.

A further aspect of example embodiments provides a computer-readable recording medium storing a computer program for execution by a processor that when executed by the processor causes the processor to perform the method for creating the composite image.

The briefly summarized features in the present disclosure are merely some aspects of example embodiments, and they are not intended to limit the scope of example embodiments.

With the use of example embodiments, it is possible to create a personalized composite image.

With the use of example embodiments, it is possible to create a composite image by identifying at least one object included in an input image and composing a region of each identified object using a content associated with a corresponding one of the identified objects.

With the use of example embodiments, it is possible to create a composite image by identifying at least one chroma key region included in an input image, identifying an object associated with the chroma key region, and composing a region of the identified object using a content associated with the corresponding object.

Some example embodiments can provide a user device, a server, or a system which serves as a composite image creation apparatus for performing the method for creating a composite image.

Some example embodiments can provide a computer-readable recording medium storing a computer program for execution by a processor that when executed by the processor causes the processor to perform the method for creating a composite image.

The effects and advantages that can be achieved by the present disclosure are not limited to the above-mentioned ones, and those skilled in the art can clearly appreciate other effects and advantages which are not mentioned above from the following description.

### BRIEF DESCRIPTION OF THE DRAWINGS

FIG. 1 is a diagram illustrating a system in which a method for creating a composite image according to one example embodiment can be used;

FIG. 2 is a block diagram illustrating one example embodiment of a composite image creation apparatus performing the method for creating a composite image, according to one example embodiment

FIG. 3 is a diagram illustrating an example input image used in one example embodiment

FIG. 4 is a diagram illustrating objects included in an input image and identified by an object identification unit;

FIGS. 5A, 5B, and 5C are diagrams illustrating example candidate contents that can be used to compose with each object region identified in the input image;

FIG. 6 is a diagram illustrating an example of an output image (e.g., composite image) resulting from synthesizing contents determined by a content determination unit with the respective identified object regions; and

FIG. 7 is a flowchart illustrating a method for creating a composite image according to one example embodiment.

### DETAILED DESCRIPTION

Hereinafter, example embodiments of the present disclosure will be described in detail with reference to the accompanying drawings to the extent that the present disclosure can be easily carried out by those skilled in the art. However, the present disclosure may be embodied in various forms and should not be construed as being limited to the example embodiments described herein.

In describing the example embodiments, well-known functions or constructions will not be described in detail when it is determined that they may obscure the spirit of the present disclosure. Further, components not associated with the present disclosure are not shown in the drawings and like reference numerals are given to like components.

It is to be understood in the following description that when one component is referred to as being “connected to”, “combined with”, or “coupled to” another component, the expression may include not only direct connection but also indirect connection between the components. It will be further understood that when a component “comprises” or “has” another component, it means that the component may further include another component, not excluding another component unless stated otherwise.

It will be understood that, although the terms “first”, “second”, etc. may be used herein to describe various components, these components should not be limited by these terms. These terms are only used to distinguish one component from another component. Accordingly, within the description of the present disclosure, a first component in one example embodiment may be referred to as a second component in another example embodiment, and likewise a second component in one example embodiment may be referred to as a first component in another example embodiment.

In the following description, components are discriminated from each other to clearly describe their characteristics, but it does not mean that they are necessarily physically separated. That is, a plurality of components may be integrated in one hardware or software module and one component may be divided into a plurality of hardware or software modules. Accordingly, an integrated form of different components or divided forms of one component fall within the scope of the present disclosure even though not specifically stated.

In the following description, components described in various example embodiments may not be all necessarily required but some components may be optional. Accordingly, an example embodiment composed of a subset of the components included in an arbitrary example embodiment also falls within the scope of the present disclosure. Further, an example embodiment resulting from adding at least one component to a certain example embodiment described above also falls within the scope of the present disclosure.

In addition, in this specification, the term “network” is a concept including both cable networks and wireless networks. The network refers to a communication network through which data can be exchanged between a device and a system or between devices and is not limited to a specific network.

In the present specification, the device may be a stationary device such as a home appliance equipped with a personal computer (PC) function or a display function or may be a mobile device such as a smartphone, a tablet PC, a wearable device, and a head mounted display (HMD) device. Alternatively, the device may be a computing device, a vehicle, or an Internet of Things (IoT) device each of which is operable as a server. That is, in the present specification, the device refers to any kind of device capable of performing a composition image creation method of the example embodiments, and thus is not limited to a specific type.

In addition, in this specification, the term “image” refers to all kinds of media content that a user can view from a display unit of a user device (e.g., client device). That is, examples of the image include a still image, a moving image (also called video), and a stream of media content.

System and Device Construction

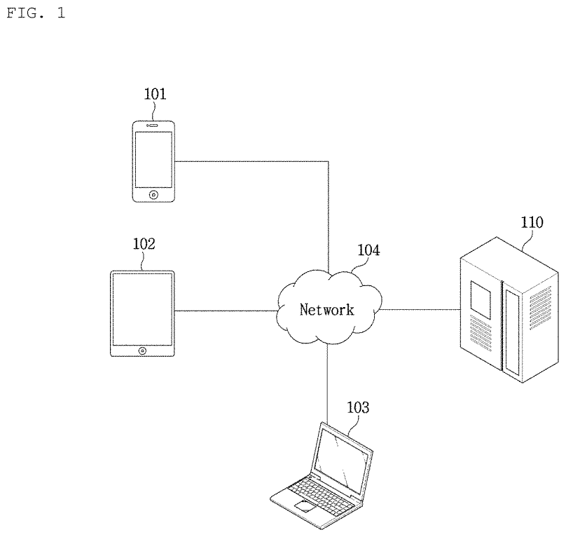

FIG. 1 is a diagram illustrating a system in which a composition image creation method according to one example embodiment is performed.

The system includes one or more user devices 101, 102, and 103 and a server 110 which is connected to each user device through a network 104.

Each of the user devices 101, 102, and 103 refers to a client device and is connected to the server 110 via the network 104. Therefore, each of the user devices 101, 102, and 103 can download images or media content from the server 110 and display the downloaded images or media content.

The server 110 stores many images and a vast amount of content in the memory thereof or in a separate database. The server 110 has a function of identifying each user and a function of accumulating and storing various kinds of information such as user information, image information, and content information.

For example, when a user gains access to the server 110 by inputting desired (or alternatively, predetermined) access information (for example, user ID and password) through his or her user device 101, 102, or 103, the server 110 identifies the user on the basis of the access information.

The records of user accesses to the server 110 and services used by the identified user are stored in the storage unit of the server 110 as history information. For example, the history information may include search records, content request records, media content playback records, and uploading records. The user may access to the server 110 and input information about his/her gender, date of birth, age, health status, occupation, address, etc. This kind of information is stored in the memory of the server 110 as personal information. In addition, the user may gain access to the server 110 and directly input his/her hobbies, interests, etc. This kind of information is stored in the memory of the server 110 as preference information.

The history information, personal information, and/or preference information are collectively referred to as user profile information in this specification. The user profile information is partially or entirely stored in a corresponding one of the user devices 101, 102, and 103 and/or the server 110. The user profile information is used in the composition image creation method according to the present example embodiment.

The composition image creation method according to the present example embodiment can be performed in various types of devices. For example, all of the operations to create a composite image may be performed in the server 110 or each of the user devices 101, 102, and 103. In some example embodiments, some operations may be performed in the server 110 and the other operations may be performed in the user device 101, 102, or 103.

The method for creating the composition image according to the present example embodiment can be performed in the server 110.

For example, the server 110 may determine an image to be transmitted to the user. In some example embodiments, an image to be transmitted to the user may be determined according to a request from the user. In some example embodiments, an image to be transmitted to the user may be determined according to a request from the server 110 or a service provider. For example, images that satisfy specific criteria or that belongs to specific categories may be transmitted to the user according to a request from a service provider (e.g., content provider). The server 110 creates a composite image from the input image to be transmitted to the user by performing the composition image creation method, according to the present example embodiment. The server 110 transmits a composite image to the user device 101, 102, or 103 through the network 104. The user device 101, 102, or 103 outputs the transmitted composite image.

When information stored in the user device 101, 102, or 103, or a user input is desired to create a composite image, the server 110 may obtain such information or the user input by communicating (e.g., exchanging data) with the user device 101, 102, or 103 through the network 104. For example, in the case where a user input is desired to select one selection content to be synthesized among at least one candidate content associated with the composite target object within the input image, the server 110 may provide the multiple contents as candidate contents to the user device 101, 102, or 103 to allow the user to select one of the candidate contents. The server 110 may perform the subsequent step on the basis of the user input. Similarly, in the case where user profile information is desired to determine a insertion content to be synthesized with a region of an object identified in an input image and is stored in the user device 101, 102, or 103, the server 110 may receive the user profile information from the user device 101, 102, or 103 by making a request for the user profile information. Then, the server 110 may perform the subsequent step on the basis of the received user profile information.

In some example embodiments, the composition image creation method may be performed in a client device.

For example, the user device 101, 102, or 103 may receive an image transmitted from the server 110. As mentioned above, the image transmitted from the server 110 may be designated by a user or a service provider. The user device 101, 102, or 103 creates a composite image from the input image received from the server 110. That is, the user device 101, 102, or 103 may perform the composite image creation method on the input image based on the received image to create a composite image. The user device 101, 102, or 103 may display the created composite image on the display unit thereof so that the user can enjoy the composite image.

When images, contents, or information stored in the server 110 is desired to create a composite image, the user device 101, 102, or 103 may obtain the desired images, contents, or information by communicating (e.g., exchanging data) with the server 110 through the network 104. For instance, when a content associated with an object which is present in an input image is stored in the server 110, the user device 101, 102 or 103 may receive the content associated with the object from the server 110 by making a request for the content. When there are multiple received contents, the user device 101, 102, or 103 may display the multiple contents on the display unit thereof as candidate contents and determine one of the candidate contents as an insertion content (hereinafter, sometimes, simply referred to as an insertion content for convenience of description) to be used for image composition according to the user selection or on the basis of the history information of the user. When only one content is received, the user device 101, 102, or 103 may determine the received content as the insertion content. When the content to be used for image composition is determined, the user device 101, 102, or 103 may create a composite image by using the content. Similarly, in the case where the user profile information is desired to determine a content to be used for image composition to create a composite image and the user profile information is stored in the server 110, the user device 101, 102, or 103 may receive the desired information from the server 110 by making a request and then perform the subsequent step.

Some steps for creation of a composite image may be performed by the server 110 and the other steps may be performed by the user device 101, 102, or 103.

For example, among the steps for creation of a composite image, an object identification step may be performed in the server 110, and a content determination step and a content composition step may be performed in the user device 101, 102, or 103. In some example embodiments, the object identification step and the content composition step may be performed in the server 110 and the content determination step may be performed in the user device 101, 102, or 103. Combinations of the steps performed by the server 110 and the steps performed by the user device 101, 102, or 103 are not limited to the examples described above. The combination of the steps performed by the service 100 and the steps performed by the user device 101, 102, or 103 may be diversely changed. The determination on which steps are performed by the server 110 and which steps are performed the user device 101, 102, or 103 may be made according to the computing power, data storage capacity, and network environment of the server 110 or the user device 101, 102, or 103.

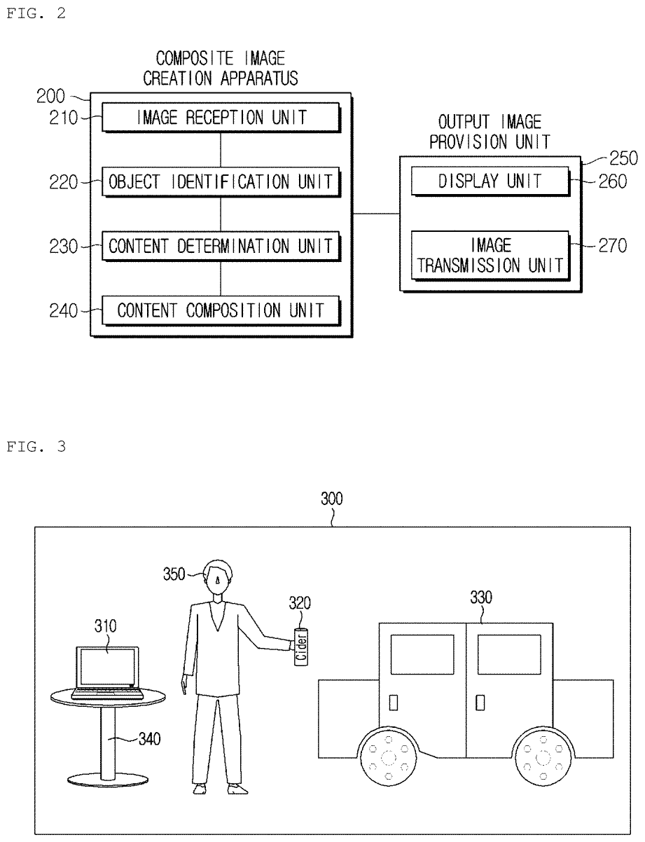

FIG. 2 is a block diagram illustrating a composite image creation apparatus according to one example embodiment. The composite image creation apparatus may perform the composite image creation method according to one example embodiment.

As described above, since the image composition method according to example embodiments can be performed only by the user device or the server, a composite image creation apparatus 200 illustrated in FIG. 2 may be built in the server or the user device. In some example embodiments, the composite image creation method may be performed by the server and the user device in a distributed manner. In this case, the serer may be equipped with some units of the composite image creation apparatus 200 and the user device may be equipped with the remaining units.

As illustrated in FIG. 2, the composite image creation apparatus 200 includes an image reception unit 210, an object identification unit 220, a content determination unit 230, and a content composition unit 240. A composite image created by the composite image creation apparatus 200 may be also referred to as an output image hereinafter. The composite image may be provided to the user via an output image provision unit 250. When a composite image is generated by the user device, the output image provision unit 250 may be a display unit 260 capable of displaying the output image thereon. The display unit 260 may be a display screen provided on the user device. When a composite image is generated by the server, the output image provision unit 250 may be an image transmission unit 270 that transmits the output image to the user device. The image transmission unit 270 may be a communication module with which the server is equipped.

The image reception unit 210 may receive an input image to undergo image composition. The image reception unit 210 built in the user device may receive an image from the storage unit of the server or a separate database through a network as an input image. In some example embodiments, the user device may receive an image captured by an image acquisition unit such as a camera as an input image. In the case where the server is equipped with the image reception unit 210, the image reception unit 210 may receive an image from the storage unit of the server or a separate database as an input image.

Various units included in the composite image creation apparatuses may be various functional units of one or more processors. The various units or apparatuses (or interchangeably, various functional units) that perform various operations and/or functions are described to increase the clarity of the description. However, one or more processors according to example embodiments of the present inventive concepts are intended to be limited to the described various units. For example, in some example embodiments, the various operations and/or functions of some of the various functional units may be performed by other ones of the various functional units. Further, one or more processor may perform the operations and/or functions of the various units without sub-dividing the operations and/or functions of the one or more processors into these various functional units. For example, the one or more processors may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc.

FIG. 3 is a diagram illustrating an example input image used in one example embodiment.

Referring to FIG. 3, an input image 300 may include various objects such as a display screen 310 of an electronic device, a drink can 320, a car 330, a table 340, and a person 350. The input image 300 may include metadata including image type information and object information in the image. For example, the image type information may refer to information representing whether the input image includes an object (hereinafter, simply referred to as “composition target object” for convenience of description) to undergo an image composition process. In some example embodiments, the image type information may refer to information representing whether the input image includes a chroma key region. Whether to perform the method for creating the composite image on the input image may be determined on the basis of the image type information. In some example embodiments, the object information may include the location, type, size, and area of each object included in the input image. In the case where the image type information does not include information on chroma key regions, the composite image creation apparatus 200 may perform the composite image creation method when receiving a request messages for identification of a composition target object from the user device and/or receiving an approval from the server.

Referring to FIG. 2, the object identification unit 220 may identify a composition target object included in the input image. The composition target object may be identified for each input image. In the case where the input image is an image (for example, a moving picture, a time lapse image, an image containing multiple picture images, or the like) composed of multiple frames, the step of identifying composition target objects may be performed frame by frame, frame group by frame group, or at desired (or alternatively, predetermined) time intervals.

In this case, various known methods can be used to identify composition target objects per input image or per frame. When the information on composition target object in the input image is included as metadata, the composition target objects included in the input image can be identified on the basis of the metadata.

In some example embodiments, the metadata of each frame of the input image may include information on each composition target object. For example, the metadata of the tenth frame of the input image may include information indicating that the display screen of an electronic device present in the tenth frame is a composition target object. In some example embodiments, when receiving a request message for identification of a composition target object, the object identification unit 220 may identify a region corresponding to the display screen of the electronic device in the tenth frame as a composition target object using an object recognition technique.

The object recognition technique for identifying composition target objects may recognize various objects such as the display screen 310, the drink can 320, the car 330, the table 340, and the person 350 in the input image 300 and identify the composition target object among various objects. For example, the object recognition technique may involve image classification, object localization, object detection, and determination as to whether or not a detected object is a composition target object. The image classification may predict a category list of related class for each object in the input image 300 and generate a class label for each object. The object localization may allocate a bounding box indicating the location and the scale of one instance corresponding to the category list of each object for each object present in the input image 300. The object detection may assign bounding boxes of all of the instances corresponding to each category list for all objects in the input image 300 on the basis of information according to image classification and object localization. Further, the object detection may generate label including the detailed type of the object and the prediction probability for each bounding box. The determination as to whether or not a detected object may be a composition target object is a determination of whether to designate the predicted detailed type of the object as a composition target object according to desired (or alternatively, predetermined) criteria. For example, when the display screen 310, the drink can 320, the car 330, the table 340, and the person 350 are detected as the detailed types of the objects in the input image 300, in the case where the desired (or alternatively, predetermined) criterion is that all the objects except for the person 350 and the table 340 may be designated as composition target objects, the display screen 310, the drink can 320, and the car 330 are determined as composition target objects. In some example embodiments, in terms of the location, size, motion, and the like of each of the detected objects in the input image 300, objects that satisfy desired (or alternatively, predetermined) values or desired (or alternatively, predetermined) value ranges may be designated as the composition target objects. At least some tasks involved in the object recognition technology may be implemented by applying a deep learning model. The object recognition technology to which the deep learning model is applied may be a region-based convolutional neural network (R-CNN) model family or a YOLO model family. The R-CNN model family may include R-CNN, Fast R-CNN and Faster R-CNN. The YOLO model family may include YOLO, YOLOv2 and YOLOv3. In addition to the object detection, object segmentation of indicating instances of recognized objects by highlighting the specific pixels of each object relating bounding boxes instead of bounding boxes may be performed.

In some example embodiments, the object identification unit 220 may identify composition target objects present in the input image by identifying chroma key regions in the input image. In some example embodiments, each chroma key region may be associated with a composition target object. Therefore, identification of a chroma key region may lead to identification of the associated composition target object.

There are various technologies for identifying chroma key regions. As described above, the chroma key region may refer to a region to be synthesized with other content and is expressed in a special form so that it can be easily identified or removed. For example, the chroma key region may be expressed and identified with a desired (or alternatively, predetermined) color key. For example, the chroma key region may be expressed in a blue-based color, but is not limited thereto. The chroma key region may be expressed in a desired (or alternatively, predetermined) color such as a green-based color or a red-based color. When the input image includes multiple chroma key regions, the chroma key regions may be expressed in different colors, respectively.

For example, three object regions corresponding to the display screen 310, the drink can 320, and the car 330 among composition target objects included in the input image 300 may be chroma key regions for image composition. In this case, all of the three chroma key regions may be expressed in the same series of colors (for example, blue series). The chroma key regions can be identified with the corresponding color key. In some example embodiments, the three chroma key regions may be expressed in two or more different series of colors (for example, blue series and green series), and the chroma key regions may be identified with respective color keys. Information on in which color each chroma key region may be expressed or information on each color key may be predefined in the server and the user device. In some example embodiments, the information may be transmitted from the server to the user device or may be contained in the input image 300 as the metadata thereof.

The color key used for the identification of the chroma key region may not indicate only one color, but may indicate a color range that can be expressed in a range including a corresponding color. For example, when blue is used as a chroma back, the color key of the chroma back may not indicate only a color represented by (R, G, B)=(0, 0, 255) but may indicate a color range (for example, (R, G, B)=(0 to 10, 0 to 10, 245 to 255)). Thus, it is possible to identify and remove the chroma key region more reliably. However, when the range of colors representing a color key is excessively wide, a region that is actually not the chroma key region may be erroneously identified as the chroma key region. Therefore, the range of colors may be determined to mitigate or prevent this problem. After identifying the chroma key regions present in the input image using the color keys, the number of pixels in each chroma key region or the area of each chroma key region may be compared with a desired (or alternatively, predetermined) threshold value. For example, when the value of the area of the chroma key region is less than a desired (or alternatively, predetermined) threshold value, it may be determined that the region is not a chroma key region. In other words, in order to more accurately identify the chroma key regions, only regions having a size greater than or equal to a desired (or alternatively, predetermined) threshold value, among multiple chroma key regions identified with color keys, may be finally determined as the actual chroma key regions. The desired (or alternatively, predetermined) threshold value may be predefined in the server and/or the user device. In some example embodiments, the desired (or alternatively, predetermined) threshold value may be transmitted to the user device from the server or may be contained in the input image 300 as metadata.

In the case where multiple chroma key regions may be expressed in respectively different series of colors, a composition target object associated with the chroma key region may be identified with a color key corresponding to each of chroma key regions. For example, as shown in Table 1, a color key (hue) indicating a chroma key region is associated with a composition target object. In this case, the composition target object may be identified using information on the association.

TABLE 1

| | Associated composition |
|---|---|
| Color key | target object |
| Blue | Display screen |
| Green | Drink can |
| Red | Car |

For example, when a chroma key region expressed in blue series identified in the input image 300, it may be determined that the composition target object corresponding to the chroma key region is associated with the display screen. Further, when a chroma key region whose color key is indicated as green is identified in the input image 300, it may be determined that the chroma key region is associated with the drink can. Similarly, it may be determined that a chroma key region with a red chroma back is associated with the car.

In another example embodiment, the composition target object associated with the chroma key region may be identified using the size and shape of the identified chroma key region. For example, as shown in Table 2, objects are associated with the shapes of identified chroma key regions, respectively, and the composition target object may be identified on the basis of the relationships.

TABLE 2

| Shape | Associated object |
|---|---|
| Rectangular | Display screen |
| Cylindrical | Drink can |

For example, when an identified chroma key region has a rectangular shape, it may be determined that the chroma key region is associated with the display screen. When an identified chroma key region has a cylindrical shape, it may be determined that an object associated with such a chroma key region is the drink can.

Further, as shown in Table 3, the size of the identified chroma key region is associated with an object, and the composition target object may be identified on the basis of the relationship.

TABLE 3

| Size (pixels) | Associated object |
|---|---|
| 350*200 | Display screen of a large TV |
| 100*60 | Display screen of a laptop |
| | computer |
| 50*30 | Display screen of a mobile |
| | phone |

For example, when the chroma-key area, whose size is determined to be 350*200 pixels in the input image 300 may be determined to be associated with the display screen of a large TV. For example, when the size of the chroma key region 100*60 pixels is determined in the input image 300, the chroma key region may be determined to be associated with the display screen of a laptop computer. When a chroma key region having a size of 50*30 pixels is identified in the input image 300, an object associated with the chroma key region may be determined to be the display screen of a mobile phone.

Further, for example, a chroma key region having a size of 350*200 pixels or more in the input image 300 may be determined to be the display screen of a large TV. A chroma key region having a size of 50*30 pixels or less may be determined to be the display screen of a mobile phone. A chroma key region having a size other than those sizes may be determined to be the display screen of a laptop computer. The sizes of the chroma key regions for the respective objects are not limited to the above mentioned examples but may be set to various values or various value ranges.

In the example embodiment concerning Table 3, the determination about the size of the chroma key region may be based on an actual size of the chroma key region and a desired (or alternatively, predetermined) threshold value. The threshold value may be provided as the metadata of the input image, may be predefined, or may be calculated on the basis of the size of a reference object in the image. For example, when a person is present in an input image, the reference object may be the person.

Further, two or more techniques for identifying a composition target object associated with an identified chroma key region may be combined. For example, as shown in Table 4, each composition target object may be associated with a combination of the color key, size, and shape of an identified chroma key region and the composition target object is identified on the basis of information on the combination.

TABLE 4

| Color key | Shape | Size | Associated object |
|---|---|---|---|
| Blue | Rectangular | 350*200 | Display screen of a |
| | | | large TV |
| | | 100*60 | Display screen of a |
| | | | laptop computer |
| | | 50*30 | Display screen of a |
| | | | mobile phone |
| | Cylindrical | — | Drink can |
| Green | — | — | Car |

That is, when a chroma key region has a color key of blue and a rectangular shape, it may be determined that the chroma key region is associated with the display screen of one object among a large TV, a laptop computer, and a mobile phone depending on the size of the chroma key region. When a chroma key region has a color key of blue and a cylindrical shape, it may be determined that the chroma key region is associated with the drink can. When a chroma key region has a color key of green, it may be determined that an object associated with the chroma key region is the car.

Other various techniques to identify objects in the image can be used as well as the above-described ones. For example, a method of detecting objects included in an image and classifying the objects using a deep learning-based artificial neural network such as convolutional neural network (CNN) may be used.

The composition target object included in the input image may be identified by analyzing each frame of the input image. The above-described method of identifying a composition target object from an input image can be also used to identify a composition target object included in the image of each frame.

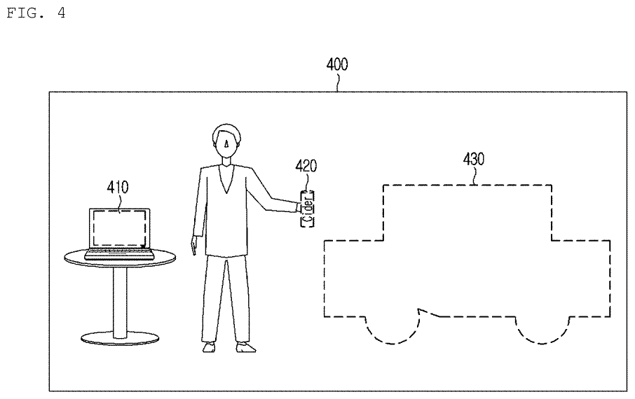

FIG. 4 is a diagram illustrating objects included in an input image and identified by an object identification unit.

For example, an input image 400 may include a display screen 410, a can drink 420, and a car 430 among multiple objects as composite target objects. Drawing 4 illustrates the results of identifying the composite target objects 410, 420, 430 among the objects included in the input image 400.

Referring to FIG. 2, the content determination unit 230 determines an insertion content that to be synthesized with the region of the identified composition target object.

The insertion content may be one of the contents accessible by the composite image creation apparatus 200. The composite image creation apparatus 200 in accordance with one example embodiment may associate the composition target object with accessible contents and store content information representing a relationship information between the composition target object and each of the accessible contents. Table 5 shows an example of content information that is stored.

TABLE 5

| Content | Content | Target | Content | |
|---|---|---|---|---|
| ID | type | object | provider | Content route |
| Content 1 | mp4 | Display | LINE | http://line.me/videos/content1.mp4 |
| | | screen | | |
| Content 2 | png | Drink | AAA | /images/png/content2 |
| | | can | | |
| Content 3 | jpeg | Car | BBB | /images/jpeg/content3 |
| . . . | . . . | . . . | . . . | . . . |

In Table 5, content ID refers to an identifier of each accessible content that can be accessed by the composite image creation apparatus 200 and which is used to identify each of the accessible contents.

Content type may include information about types of contents. For example, the content type may be the information indicating whether the content is a moving image (e.g., video) or a still image. In some example embodiments, the content type may be expressed as a file extension (e.g., format of a file) of a content. For example, the file extension of a content, such as mp4, avi, png, jpeg, and tiff, may be stored as the content type. In this case, the content type indicates in which way the file of the content is encoded as well as whether the file of the content is a moving image (video) or a still image (photograph).

The target object may refer to a target object associated with the content. For example, Content 1 represents a content associated with a display screen. The content provider may refer to a provider of the content.

The content route may refer to information representing the location of the content. For example, in the case of Content 1, the content route may be information including the uniform resource locator (URL) of the content. Content 1 associated with the display screen can be obtained by accessing the corresponding URL. In this case, the content provider can easily update the content to be provided to the user by changing the content at the location represented by the corresponding URL, and Content 1 may not be stored in the composite image creation apparatus 200. In some example embodiments, as in the case of Content 2 or Content 3, the content may be stored in a storage device of the composite image creation apparatus 200. In this case, the content route may refer to a storage path leading to the location of the content stored in the storage device.

Content information may include various kinds of information on content as well as example information shown in Table 5. For example, in the case of moving image content (e.g., video content), information such as resolution, frame rate, and playback time may be included, and in the case of still image content, information such as resolution may be included.

Further, the content information may include content profile information that is an information item used when determining an insertion content on the basis of user profile information. For example, the content profile information may include information (age, gender, preferences, hobbies, history, etc.) of users who mainly consume the content or information (season, weather, time zone, region, etc.) on the environment in which each content is mainly consumed. The content profile information may be included in the content information shown in Table 5. The content profile information is compared with the user profile information. Thus, the content profile information is used to determine the insertion content to be used for image composition. For example, in Table 5, when Content 1 is an animation image whose primary consumers are children, the primary consumer in the content profile information of Content 1 is set to “child”. Afterwards, when a user to be provided with a composite image is identified as a “child” on the basis of the user profile information, Content 1 whose primary consumers are children on the basis of the content profile information may be determined as an insertion content to be synthesized with the input image. Similarly, when the time zone in which Content 2 is mainly consumed is night, the main consumption time zone for Content 2 is set to “night” as the content profile information of Content 2. Afterwards, when a time zone within which a composite image is provided to a user is identified as “night”, Content 2 for which the main consumption time zone is set to “night” on the basis of the content profile information may be determined as an insertion content used to be synthesized.

Table 5 shows one content for each target object. However, the number of contents for each target object is not limited thereto. Multiple contents may be set for each target object. Further, the information on the multiple contents may be the same. The information on the multiple contents may be totally or partially different. There may be at least one pieces of the content profile information used to determine an insertion content to be synthesized. In this case, contents selected on the basis of the at least one pieces of the content profile information may be provided to the user as candidate contents.

The insertion content to be synthesized may be determined by selecting one candidate content among at least one candidate contents associated with the identified composition target object. For example, at least one candidate contents associated with an identified composition target object are presented to the user. The user views the presented candidate contents and selects one of the candidate contents. Upon receiving the user's selection (e.g., user input), the selected candidate content is determined as the insertion content to be synthesized with the region of the identified composition target object.

The content determination unit 230 in the user device may receive multiple candidate contents associated with the identified composition target object from the server and presents them to the user. The content determination unit 230 in the server may transmit multiple candidate contents to the user device and receives a user selection for the candidate contents.

The candidate contents to be presented to the user or the insertion contents to be synthesized may be determined on the basis of the user profile information. For example, when determining a candidate content associated with the drink can 420, the user's age may be considered. That is, when the user is a minor, the candidate contents may be related to beverages (e.g., non-alcoholic drinks). The insertion contents to be synthesized may be similarly determined. For example, when the number of contents associated with the drink can 420 are two in which one is beer and the other is cola, in a case where the user is a minor, the cola may be determined as the insertion content to be synthesized. Various kinds of user profile information including personal information such as age, gender, and address, preference information such as hobbies and interests, and history information such as search history, request history, and playback history may be used for the determination of candidate contents and/or the determination of insertion contents to be synthesized. For example, candidate contents and/or insertion contents to be synthesized may be determined on the basis of a history of images reproduced (e.g., enjoyed or consumed) by the user. In this case, images or contents that are related to the playback history may be used. As a specific example, when a user has most frequently reproduced (e.g., enjoyed or consumed) the images of a specific genre, a content associated with the genre may be determined as an insertion content.

The candidate contents to be presented to the user or the insertion contents to be synthesized may be determined on the basis of environment information such as time, place, season, and weather in which the images are consumed. For example, when the season is winter, contents related to drinks that are mainly used in winter may be selected as contents related to the drink can 420. In this case, the content attributes of each content accessible by the composite image creation apparatus 200 may be stored as content information. The content attributes may be statistically used to determine whether the drink is mainly consumed in winter.

Candidate contents to be presented to the user or insertion contents to be synthesized may be determined according to the selection of a service provider that supplies the relevant services.

Candidate contents to be presented to the user or insertion contents to be synthesized may be determined by a combination of two or more methods among the methods described above.

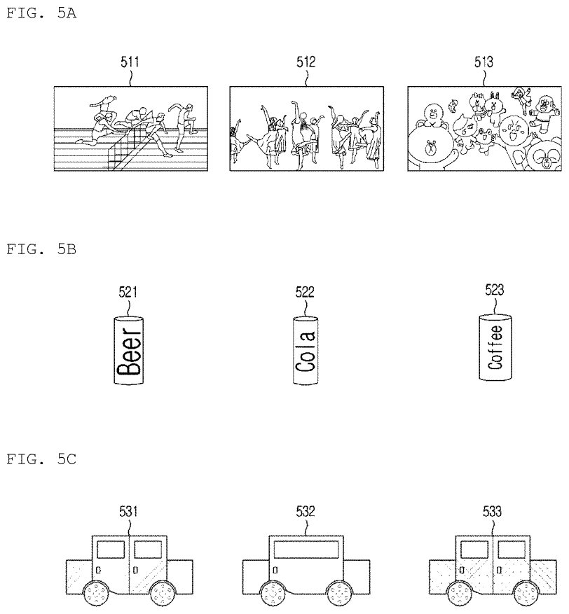

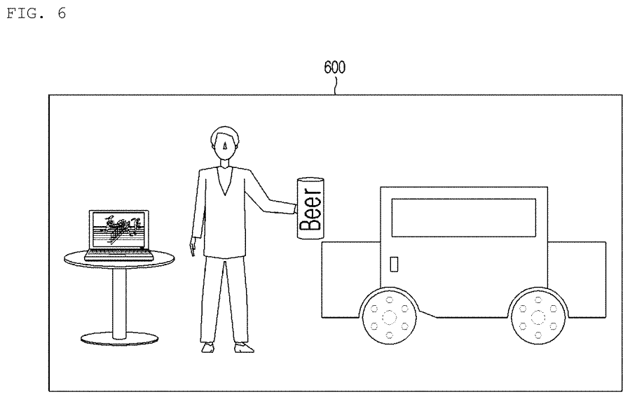

FIGS. 5A, 5B, and 5C are diagrams illustrating example candidate contents that can be used to compose with each object region identified in the input image.

FIG. 5A shows candidate contents each of which can be synthesized with the object region 410 corresponding to the display screen. For example, a sports image 511, a performance image 512, and an animation image 513 may be presented to the user as candidate contents.

FIG. 5B shows candidate contents each of which can be synthesized with the object region 420 corresponding to the drink can. For example, a beer can image 521, a cola can image 522, and a coffee can image 523 may be presented as candidate contents.

FIG. 5C shows candidate contents each of which can be synthesized with the object region 430 of the car. For example, a blue four-door vehicle image 531, a silver two-door vehicle image 532, and a red four-door vehicle image 533 may be presented as candidate contents.

For example, the content determination unit 230 may determine an insertion content for each object region among the candidate contents illustrated in FIGS. 5A-5C according to the various methods and criteria described above.

Referring to FIG. 2, the content composition unit 240 generates an output image by inserting the determined insertion contents into the respective object regions identified in the input image 400.

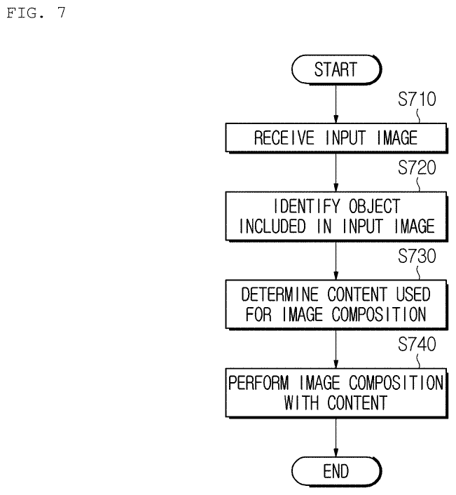

FIG. 6 is an example of an output image generated by inserting the insertion contents determined by the content determination unit 230 into the respective object regions.

An output image 600 illustrated in FIG. 6 is an image created by selecting the sports image 511, the beer can image 521, and the silver two-door image 532 for the object region 410 corresponding to the display screen, the object region 420 corresponding to the drink can, and the object region 430 corresponding to the car, respectively and synthesizing them into corresponding object regions. Based on the fact that the user's preference is the highest in sports as a result of searching the user's preference information, the sports image 511 among a plurality of candidate contents may be determined as insertion content to be synthesized for the object region 410 of the display screen. Further, to determine the insertion content for the object region 420 of can drink, the personal information of the user is checked. If the personal information of the user indicates that the user is an adult man and enjoys beer, the beer can image 521 may be determined as the insertion content for the object region 420 of the drink can. In the case of the object area 430 corresponding to the car, the blue four-door car image 531, the silver two-door car image 532, the red four-door car image 533 are presented as candidate contents to the user, and the silver two-door car image 532 cab be determined as the insertion content according to the user's selection.

There are various existing techniques for synthesizing an insertion content into the corresponding object region. For example, the area of the identified object region may be defined on the basis of the outline of the composite target object, and the insertion content may be modified to match the area of the object region. For example, the size, inclination, aspect ratio, shape, etc. of the insertion content may be changed so that the insertion content fits the corresponding object region. After the insertion content is modified to fit the object region, the modified content is synthesized with the corresponding object region.

When the input image is a multi-frame image (for example, moving image, time-laps image, or multi-picture image) composed of a plurality of frames, determination of an insertion content to be synthesized into a region of composition target object may be performed frame by frame. In some example embodiments, it may be performed frame group by frame group, or may be performed at desired (or alternatively, predetermined) time intervals. For example, when a composition target object is a drink can, an insertion content may be determined differently for each frame. In some example embodiments, the insertion content for the first to n-th frames (first frame group) may be a cola can image, and the insertion content for the n+1-th to m-th frames (second frame group) may be a beer can image. In some example embodiments, the insertion content may be changed at a time interval of 1 second.

Referring to FIG. 2, when an output image is synthesized in the user device through as described above, the output image may be displayed on the display unit 260 of the user device to allow the user to consume or enjoy the created image. When an output image is synthesized in the server, the output image may be transmitted to the user device connected to the network through the image transmission unit 270 of the server so that the user can consume or enjoy the image.

Method for Creating a Composite Image

FIG. 7 is a flowchart illustrating a method for creating a composite image in accordance with one example embodiment

As described above, a method for creating a composite image in accordance with one example embodiment can be performed solely by a user device or a server. Therefore, the method for creating a composite image of FIG. 7 may be performed by a user device or a server alone. Further, some steps performed during a method for creating a composite image in accordance with one example embodiment may be performed by a server and the other steps may be performed on a user device. Further, at least one of the steps shown in FIG. 7 may be performed through data exchange between a user device and a server. For example, as described above, when a user's selection is desired, and when content or user profile information is stored in a server or a user device, data exchange between the server and the user device may be performed.

In Step S710, an input image to be synthesized may be received. The user device may perform Step S710 by receiving an image stored in a storage space of a server or a separate database as an input image through a network, or by acquiring a new image with the use of an image acquisition device such as a camera. The server may perform Step S710 by reading out an image stored in the storage space thereof or in the separate database. The input image used in the method for creating a composite image of the present example embodiment is the same as the input image used in the composite image creation apparatus of the previous example embodiment. Therefore, hereinafter, a detailed description of the input image will be omitted.

In Step S720, composition target objects included in the input image may be identified. Various methods for identifying composition target objects included in the input image have already been described in connection with the object identification unit 220, and a duplicate description will be omitted.

In Step S730, insertion contents to be synthesized with the regions of the identified composition target objects may be determined. The details in the description of the content determination unit 230 can be applied equally to Step S730, and a duplicate description will be omitted.

For example, when multiple candidate contents is stored in the storage space of the server or the server-side database and insertion content to be synthesized is determined depending on a user input selecting one of the multiple candidate contents, Step S730 may be performed through the method described below.

When the method for creating a composite image of an example embodiment is performed by the user device, in a case where a composition target object is identified in Step S720, the user device may transmit information on the composition target object to the server. The server may identify multiple candidate contents on the basis of the information on the identified composition target objects and presents them to the user device. Next, the user device may perform Step S730 by selecting one candidate content among the multiple candidate contents.

When the method for creating a composite image of an example embodiment is performed by the server, in a case where a composition target object is identified in Step S720, the server may identify multiple candidate contents on the basis of information on the identified composition target objects and provide the multiple candidate contents to the user device. Subsequently, the server may perform Step S730 in a manner of determining an insertion content to be synthesized with the region of the corresponding identified composite target object by receiving a user input selecting one candidate content among multiple candidate contents from the user device.

Although the case where one candidate content is selected among multiple candidate contents by the user's selection has been described, example embodiments are not limited thereto. That is, Step S730 may be performed through data transfer between the server and the user device according to locations of various kinds of information (for example, user selection information, user profile information, environment information, information from a service provider, etc.) used to determine the insertion content to be synthesized.

For example, when multiple candidate contents may be stored in the storage space of the server or the server-side database, and the insertion content to be synthesized may be determined according to the user profile information, Step S730 may be performed through the method described below.

When the method for creating a composite image of an example embodiment is performed by the user device, in a case where a composition target object is identified in Step S720, the user device may transmit information on the composition target object to the server. The server may identify multiple candidate contents on the basis of the information on the identified composition target objects and presents them to the user device. Thereafter, the user device may perform Step S730 in a manner of determining an insertion content to be synthesized with the object region of the identified composition target object by selecting one candidate content among multiple candidate contents on the basis of the user profile information.

When the method for creating a composite image of an example embodiment is performed by the server, when the composition target object is identified in Step S720, the server may identify multiple candidate contents on the basis of information on the identified composition target object and determine the insertion content to be synthesized into the identified object region by requesting and receiving user profile information from the user device to select one candidate content from multiple candidate content. Step S730 may be performed in the manner described above.

In Step S740, an output image may be generated by synthesizing the determined insertion contents into the identified object regions in the input image, respectively. Various method for creating composite images have been already described when describing the content composition unit 240. Thus a duplicate description will be omitted.

As another example, when the method for creating a composite image is performed by the server, the method may further include a step of specifying a user device to which a composite image is to be transmitted. The step of specifying the user device may be performed prior to Step S710. The server may specify the user device to receive the composite image according to the user's selection, default settings, a targeted user according to type of an insertion content, material of the insertion content etc., a request from an external system other than the user. In some example embodiments, the specifying of the user device may be performed between Step S710 and Step S740 or may be performed after Step S740 in the same manner as described above.

According to the present disclosure, various output images 600 can be generated with different contents synthesized for each of composition target objects from the input image 300. The insertion contents to be synthesized may differently be determined for each user. That is, rather than that all users are provided with the same image, each user will be provided with a personalized output image generated according to user-designated factors such as a user's selection, user profile information, or other factors. Accordingly, it is possible to maximize the effect of the created image on the user or to adjust the effect to an appropriate level. For example, through the provision of a user-customized video, it is possible to maximize the effect of the video, such as the educational effect and the advertising effect of the video.

According to some example embodiments, because the composite image creation apparatus (e.g., one or more processors included in the composite image creation apparatus) uses content information (e.g., a specific data structure) including association information between one or more composition target objects and accessible contents, it may be possible for the composite image creation apparatus (e.g., one or more processors included in the composite image creation apparatus) to freely synthesize multiple contents associated with respective multiple chroma key regions while consuming less computing resources.

Although the example methods of the present disclosure are represented by a series of steps for clarity of description, they are not intended to limit the order in which the steps are performed. That is, if desired, each step may be performed in parallel or performed in series in a different order. In order to implement the method according to the present disclosure, each of the example embodiments described above can be modified such that some additional steps can be added to a corresponding example embodiment or some existing steps can be eliminated from a corresponding example embodiment. In some example embodiments, some additional steps are added and some existing steps are eliminated from a corresponding of the example embodiments.

Various example embodiments in the present disclosure are not intended to represent all of the possible combinations based on technical spirit of example embodiments but are provided only for illustrative purposes. Elements or steps described in various example embodiments can be applied independently or in combination.

A method for creating a composite image according to example embodiments may be implemented with program instructions that can be executed by various computing devices and which can be recorded in a computer-readable recording medium. The computer-readable recording medium may store program instructions, data files, data structures, and the like solely or in combination. The program instructions recorded on the medium may be ones that are specifically designed and configured to carry out example embodiments or may be publicly available to professionals in the field of computer software. Examples of the computer-readable recording medium include magnetic media such as hard disks, floppy disks, and magnetic tapes, optical media such as CD-ROMs and DVDs, magneto-optical media such as floptical disks, and hardware devices specifically configured to store and execute program instructions, such as ROM, RAM, and flash memory. Examples of the program instruction include machine language codes generated by a compiler and high-level language codes that are generated by an interpreter and which can be executed by a computer. The hardware device described above may be configured to execute at least one software module to perform a method of example embodiments, and vice versa.

Various example embodiments in the present disclosure can be implemented by hardware, firmware, or a combination of hardware and software. When implemented by hardware or a combination of hardware and software, such example embodiments can be implemented by at least one application specific integrated circuits (ASICs), digital signal processors (DSPs), digital signal processing devices (DSPDs), programmable logic devices (PLDs), field programmable gate arrays (FPGAs), general processors, controllers, micro controllers, or micro-processors.

The scope of the present disclosure covers a certain device or computer configured to execute software or machine-executable commands (for example, operating systems (OSs), application programs, firmware, programs) that enable steps in various example embodiments, and a non-transitory computer-readable medium in which such software or commands are stored so as to be executable in a certain device or computer when read out.

What is claimed is:

1. A method for creating a composite image, the method executed by a computing device including at least one processor, the method comprising:
identifying, by the at least one processor, a composition target object included in an input image;
determining, by the at least one processor, an insertion content associated with the identified composition target object; and
creating, by the at least one processor, an output image by synthesizing the insertion content with a region occupied by the identified composition target object within the input image.

2. The method according to claim 1, wherein
the input image includes at least one chroma key region, and
the identifying comprises detecting the chroma key region and identifying an object associated with the detected chroma key region as the composition target object.

3. The method according to claim 2, wherein the identifying comprises identifying the composition target object based on a color key, a size, a shape of the detected chroma key region, or any combination thereof.

4. The method according to claim 1, wherein the identifying comprises identifying the composition target object by applying an object recognition technique to an object in the input image.

5. The method according to claim 1, further comprising:
associating at least one accessible content with the composition target object; and
storing content information including association information between the composition target object and each of the at least one accessible content, in the computing device.

6. The method according to claim 5, wherein the determining comprises:
determining at least one of the at least one accessible content associated with the identified composition target object as at least one candidate content based on the content information; and
determining one of the at least one candidate content as the insertion content based on user profile information.

7. The method according to claim 6, wherein the user profile information includes at least one of personal information, preference information, or history information of a user.

8. The method according to claim 5, wherein the determining comprises:
determining at least one of the at least one accessible content associated with the identified composition target object as at least one candidate content based on the content information;
displaying the at least one candidate content;
receiving a user input selecting one of the at least one candidate content from a user of the computing device; and
determining one of the at least one candidate content as the insertion content based on the user input.

9. The method according to claim 1, wherein the creating comprises:
modifying the insertion content based on the region occupied by the identified composition target object; and
synthesizing the modified insertion content with the region occupied by the identified composition target object.

10. The method according to claim 9, wherein the modifying the insertion content comprises changing at least one factor of a size, an inclination, or a shape of the insertion content such that the insertion content matches the region occupied by the identified composition target object.

11. A server for creating a composite image, the server comprising:
one or more processors configured to execute the computer-readable instructions such that the server is configured to,
obtain an input image;
identify a composition target object included in the input image;
determine an insertion content associated with the identified composition target object;
create an output image by synthesizing the insertion content with a region occupied by the identified composition target object within the input image; and
transmit the output image to a user device through a network.

12. The server according to claim 11, wherein
the input image includes at least one chroma key region, and
the one or more processors are further configured to cause the server to detect the chroma key region and identify an object associated with the detected chroma key region as the composition target object.

13. The server according to claim 12, wherein the one or more processors are configured to cause the server to identify the composition target object based on a color key, size, shape of the detected chroma key regions, or any combination thereof.

14. The server according to claim 11, wherein the one or more processors are configured to cause the server to identify the composition target object by applying an object recognition technique to an object in the input image.

15. The server according to claim 11, wherein the one or more processors are further configured to cause the server to,
associate at least one accessible content with the composition target object, and
store content information including association information between each of the at least one accessible content and the composition target object.

16. The server according to claim 15, wherein the one or more processors are further configured to cause the server to,
determine at least one of the at least one accessible content associated with the identified composition target object as at least one candidate content based on the content information, and
determine one of the at least one candidate content as the insertion content based on profile information of a user of the user device.

17. The server according to claim 15, wherein the one or more processors are further configured to cause the server to,
determine at least one of the at least one accessible content associated with the identified composition target object as at least one candidate content based on the content information,
transmit the candidate contents to the user device,
receive a user input selecting one of the at least one candidate content from a user of the user device, and
determine one of the at least one candidate content as the insertion content based on the user input.

18. The server according to claim 11, wherein the one or more processors are further configured to cause the server to,
modify the insertion content based on a region occupied by the identified composition target object, and
synthesize the modified insertion content with the region occupied by the identified composition target object.

19. The server according to claim 18, wherein the one or more processors are further configured to cause the server to modify a size, an inclination, a shape of the insertion content, or any combination thereof such that the insertion content matches the region occupied by the identified composition target object.

20. A computer-readable recording medium storing a computer program for execution by a processor that when executed by the processor causes the processor to perform a method for creating a composite, the method comprising:
identifying a composition target object included in an input image;
determining an insertion content associated with the identified composition target object; and
creating an output image by synthesizing the insertion content and a region occupied by the identified composition target object within the input image.
